(19) United States
(12) Patent Application Publication
(10) Pub. No.: US 2026/0130361 A1
(43) Pub. Date: May 14, 2026

(54) COMPOSITION AND METHOD FOR PERFUSING TISSUE

(71) Applicant: DEKA Products Limited Partnership, Manchester, NH (US)

(72) Inventors: Franka Messner, Innsbruck (AT); Marlene Pühringer-Sturrnayr, Innsbruck (AT); Andrew K. Capulli, Auburn, NH (US); Joshua Filgate, Lyndeborough, NH (US); Bradley Hovan, Manchester, NH (US)

(21) Appl. No.: 19/239,349

(22) Filed: Jun. 16, 2025

Related U.S. Application Data
(60) Provisional application No. 63/662,162, filed on Jun. 20, 2024.

(51) Int. Cl. A01N 1/126

(52) U.S. Cl. CPC A01N 1/126

(57) ABSTRACT

A composition and method for perfusing tissue. A perfusate is composed of an endothelial cell stabilizer. thrombocyte concentrate (TC). The perfusate may further comprise a protein solution that may be an albumin-based solution or fresh frozen plasma (FFP). The perfusate composition may further comprise red blood cells. The perfusate composition may be perfused through an organ that has been removed from an organ donor and is being prepared for transport and transplant into a recipient. The perfusate composition may be perfused through an organ using a machine perfusion device.

### CROSS REFERENCE TO RELATED APPLICATIONS

The present application claims priority to provisional application No. 63/662,162 (AB406) filed on Jun. 20, 2024; contents of which are incorporated herein by reference.

### BACKGROUND

The present disclosure relates to a composition, system, and method for perfusing tissue. More specifically, the present disclosure relates to a perfusate composition and method for utilizing a perfusate composition in the perfusion of tissue.

Tissue perfusion in the organ transplant process has garnered considerable attention as a compelling alternative to the long-standing standard of care known as static cold storage (SCS). While SCS has been the conventional approach in organ transplantation, its limitations have become increasingly apparent, especially as many aspects of modem medicine continue to innovate and improve. SCS is known to increasingly impact organ health in a negative way as cold time accumulates, since the cells are not receiving oxygen, nutrients, and other factors that they would normally receive under physiologic conditions. Extended periods of cold storage pose significant challenges to organ viability and health, and after a certain amount of time passes in the cold state, the organ is no longer considered transplantable. SCS works by lowering the temperature of the organ to a point where its metabolic activity is so low that its need for blood and oxygen are greatly reduced. However, prolonged exposure to cold temperature increases the risk of ischemic injury, particularly as the duration of storage and the delay in transplantation increases, emphasizing the urgent need for alternative preservation methods.

To address the deficiencies of SCS, innovative approaches such as normothermic machine perfusion (NMP) have emerged as promising solutions. Unlike traditional cold storage, NMP involves the continuous perfusion of tissues at physiologic temperature, providing them with oxygen, nutrients, and other factors that are essential for cellular function and viability. With the implementation of NMP on recovered organs, research has shown that damage to the organ can be significantly reduced which in turn, increases the potential for a successful outcome for the subsequent transplant. NMP also extends preservation time and provides assessment data that can be used to evaluate the tissue, which will decrease tissue non-utilization rate, and in so doing, increase the amount of tissues that are viable for transplant. In addition to perfusing at normothermic temperatures, systems can function at subnormothermic temperatures as well.

The successful implementation of NMP requires the use of perfusates that can support cellular metabolism, prevent or limit ischemic injury, and place the tissue in a condition suitable for transplant. During NMP, various compositions of perfusate can be utilized, including red-blood-cell-based perfusates. However, NMP does not cure all of the deficiencies encountered in the tissue transplant process. The various perfusate solutions, often containing components such as red blood cells, electrolytes, proteins, nutrients, and buffers have been developed to maintain cellular integrity and function of the tissue. While these solutions have shown promising results of the potential NMP to replace SCS, there are also possible complications that can arise from machine perfusion. Specifically, hematuria and the formation of hematomas in the tissue indicate damage. Excess bleeding in a tissue being prepared for transplant may result in significant functional alteration and permanent damage to the tissue/organ. The greater the level of bleeding may increase the risk of complication before, during, and after transplant.

Perfusates serve as the cornerstone of NMP, they play a pivotal role m tissue preservation by providing the necessary nutrients, oxygen, and protective elements meant to stabilize the tissue during perfusion. A perfusate is intended to mimic the physiological environment necessary for a tissues cellular makeup to metabolize. As it stands, the current standard for perfusates lacks an ideal composition that limits injury and bleeding, and maximizes the health of the tissue.

In the search for ideal perfusate compositions, many combinations have been tried. Red blood cell based solutions have emerged as a common choice for NMP, which is no surprise as blood would be flowing through the organ in vivo. In testing different perfusates during liver perfusion different research groups have revealed intriguing insights into the relationship between perfusate composition and post-transplant outcomes. Said research groups have concluded that post-transplant portal vein complication was directly proportional to platelet concentration, and that the detrimental and non-hemostatic properties of platelets have not been properly studied or weighed in the context of normothermic machine perfusion.

What is needed is a composition for a perfusate that reduces the bleeding of a tissue undergoing machine perfusion. What is needed is a composition for a perfusate that improves a transplantable tissue's status. What is needed is a method for perfusing a tissue using a perfusate that reduces the potential for tissue bleeding during machine perfusion. What is needed is a method for perfusing a tissue using a perfusate that improves a transplantable tissue's status.

### SUMMARY

In accordance with some configurations, the present teachings include a composition and method for perfusing tissue. The composition of the present teachings derives from internal studies showing the benefits of perfusing organs with a bleeding reduction compound such as platelets (thrombocyte concentrate) or an endothelial cell stabilizer. One of the largest problems encountered during NMP is the formation of hematomas, but internal studies have shown that the addition of a bleeding reduction solution, such as thrombocyte concentrate (TC) has worked to decrease hematoma formation. The composition of the present teachings can include using TC. The composition of the present teachings can include using a protein solution. The composition of the present teachings can include using fresh frozen plasma (FFP) as the protein solution. The composition of the present teachings can include using an albumin-based solution as the protein solution. The composition of the present teachings can include using TC and an albumin-based solution. The composition of the present teachings can include using FFP and TC. The composition of the present teachings can include using FFP, TC, and red blood cells (RBC). In some aspects, the FFP can increase coagulative capacity. In some aspects, the composition of the present teachings leads to stable perfusions. In some aspects, other endothelial cell stabilizers as bleeding reduction solutions may be used instead of TC, including but not limited to, Dabigatran, Poloxymer (P)188, iCMO12/iCMO20. In some aspects, the composition of the present teachings is perfused at normothermic temperatures. In some aspects, the composition of the present teachings is perfused at subnormothermic temperatures.

The method of the present teachings can include making a perfusate composition using TC. The method of the present teachings can include making a perfusate using a protein solution. The method of the present teachings can include making a perfusate composition using FFP as the protein solution. The method of the present teachings can include making a perfusate using an albumin-based solution as the protein solution. The method of the present teachings can include making a perfusate composition using TC and FFP. In an aspect, the proportionality of the elements of the perfusate are adjusted based on the status and needs of a tissue that is to be perfused. The method of the present teachings can include perfusing a tissue with the perfusate.

The method of the present teachings can include pumps, valves, and a controller that can move perfusate through a tissue. The method can include features to assist in monitoring the health of the tissue. The system of the present teachings is fully configured to perfuse and provide nutrition for transplant tissue such as human tissue. Other features of the system of the present teachings include, but are not limited to, pumps, disposable and durable parts, and sensors. The method of the present teachings can include at least one controller or processor that can enable valves and pumps to perfuse fluids through tissue, for example, but not limited to, a human tissue.

The system of the present teachings can include a pump subsystem that can enable tissue perfusion and perfusate recirculation. The pump subsystem can pump perfusate, for example blood and other additives, through the tissue. The blood can include whole blood or packed red blood cells, or TC, or FFP, for example. In some configurations, the pump subsystem can enable perfusate flow at a rate of up to 1000 ml/min at a pressure of 20-120 mmHg. In some aspects, the flow rate is between 0-900 ml/min. Flow can optionally be pulsatile, and the rate can be adjustable. As an example, a low flow rate can be required for cold or damaged tissue. As tissue function improves, the flow rate can be adjusted to accommodate the changed conditions. Pulsatile flow or a flow rate controlled by physiological parameters can both be accommodated by the pumps of the present teachings.

The role of the perfusion loop is to provide basic biological functions that would otherwise take place in the body. These include oxygenation, nutrient supply, thermal control, and removal of carbon dioxide. Oxygenation and carbon dioxide control are conducted through the use of a membrane oxygenator. A heat exchanger is used to maintain desired perfusate temperature. The perfusion fluid leaves the tissue, is passed through an oxygenator, is passed through a heat exchanger, and is then pumped back into the tissue. Nutrients are suppled in the perfusion solution and can be added manually or through the use of automated infusion pumps. Output generated by the tissue flows out of the tissue and is available for sampling through sterile sample ports. Output can be directed back into the perfusion loop or discarded. Output flow rates and volumes are measured and stored by the system. In the event that recirculating output proves to be a challenge, the system can be modified such that the output is collected or potentially passed through a dialysis loop.

The perfusion loop acts like a maintenance loop for the system allowing for filling or draining of the fluid reservoir and recirculation of the fluid from the tissue reservoir, essentially stirring the tissue reservoir. This loop can include the infusion pumps so that infusions can be delivered, diluted, and mixed into the perfusate instead of being passed directly into the tissue. Some or all of the infusion pumps can be made part of the perfusion loop. In some configurations, the system includes a bypass valve that can be opened during priming when bubbles are detected. To introduce new blood or drain the system, the system includes at least one valve associated with the infusion path. In some configurations, a pinch valve can be associated with incoming perfusate, while another pinch valve can be associated with a drain path. In an aspect, pneumatic valves can be used. Other types of valves are contemplated by the present teachings. The perfusate pump can also drain the tissue enclosure.

The method of the present teaching pumps perfusate in a closed loop through the tissue. In an aspect, the system includes one or more fluid pumps to accomplish the perfusion. Types of perfusion pumps include, but are not limited to including, axial flow pumps, peristaltic pumps, diaphragm pumps, pumping cassettes, roller pumps, centrifugal pumps, pulsatile pumps, and non-occlusive roller pumps. A pump that can enable the perfusion of the system of the present teachings can deliver physiologic blood flows against high resistance without perfusate, provides flows that are exact and easily monitored, creates no turbulence or stagnation, and can be manually operable in the event of a power failure. In some configurations, extracorporeal membrane oxygenation (ECMO)-type devices are used to perfuse and oxygenate the blood in the system. In some configurations, the oxygenator device uses silicone membrane contactors. The perfusate is pumped through several possible modification stations and past several sensors before entering the tissue.

### BRIEF DESCRIPTION OF THE DRAWINGS

The foregoing features of the disclosure will be more readily understood by reference to the following description, taken with reference to the accompanying drawings, in which:

FIGS. 1A-1B are schematic block diagrams of the composition, system, and method of the present teachings for perfusing tissue;

FIGS. 2A-2C are schematic perspective, of the composition, system, and method of the present teachings for perfusing tissue;

FIGS. 3A-3C are schematic perspective diagrams of the composition, system, and method of the present teachings for perfusing tissue; and

FIG. 4 is a block diagram of the of the composition, system, and method of the present teachings for perfusing tissue.

### DETAILED DESCRIPTION

The composition and method of the present disclosure include a perfusate solution having a bleeding reduction compound, and perfusing the solution through a tissue. Further including, but not limited to including, a perfusion pump assembly pumping perfusate through the tissue, tubing connecting a tissue container assembly with the perfusion pump assembly, a tissue gas adjustment device maintaining a myriad of characteristics of the perfusate, and sensors providing data about the tissue necessary to maintain the tissue. Also including but not limited to including, a thermal adjustment assembly maintaining the temperature of the perfusate, and a pneumatics assembly driving the perfusion pump assembly to circulate the perfusate.

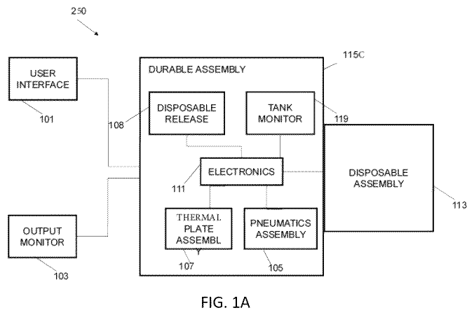

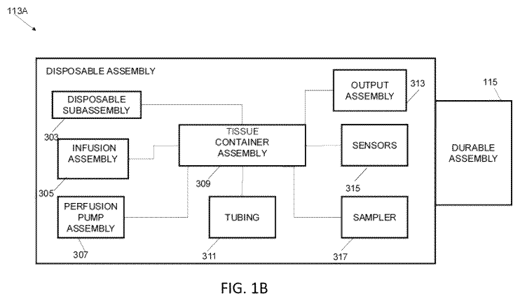

Referring to FIG. 1A, moving perfusate, nutrition, and medication to and through the tissue is enabled by pneumatics assembly 105, which drives at least one disposable pump. In an aspect, a pneumatic valve assembly can deliver the quantities required without damaging the traversing fluid. In an aspect, perfusate can be composed of any combination of a bleeding reduction solution, protein based solution, and blood solution, including but not limited to TC, FFP, and RBC.

Referring now to FIG. 1B, in an aspect, pneumatic infusion assembly 305 delivers medications and nutrition to the perfusate. In an aspect, TC and FFP can be added to the perfusate to minimize bleeding of the tissue. In an aspect, nutrition can be delivered by one pneumatic infusion pump while medication can be delivered by another pneumatic infusion pump. In some aspects, other endothelial cell stabilizers may be used instead of TC, including but not limited to, Dabigatran, Poloxymer (P)188 and/or iCMO12/iCMO20. In an aspect, the pneumatic infusion pumps are controlled by a controller. In an aspect, medications and/or nutrition can be delivered by a stand-alone, remotely-operated pump that is not associated with the pneumatic system. Pump choices depend upon the desired delivery rate and other factors associated with the delivered product. In an aspect, the infusion pump can include a pneumatically-driven membrane cassette pump designed to deliver infusion materials according to desired flow rates and pressures. Perfusion pump assembly 307 includes at least one perfusion pump. In an aspect, the perfusion pump enables the flow of perfusate to and through the tissue. In an aspect, the perfusion pump can include one or more pneumatically-driven membrane cassette pumps. Other types of pumps are contemplated by the present teachings. An oxygenator provides oxygen to the perfusate. The hood mount provides a surface for an environmental barrier to be coupled with the tissue container. The tissue strap maintains the position of the tissue on the tissue platform.

Referring now to FIG. 12A the flow and date/control/electrical connections of an exemplary configuration of the system of the present teachings is shown. In an aspect, controller 279 controls the sequencing of events that move the perfusate, medications, and nutrition from point to point. Starting with perfusate reservoir 284, perfusate flows into and through perfusion pump 275. The pressure of the perfusate is then measured inline by pump pressure sensor 273 before the perfusate enters oxygenator 271. Oxygenated perfusate flows into heat exchanger 285 in which the perfusate temperature is adjusted to a desired level and then is assessed by inline sensors 291. Bubbles are removed by air trap 293 and inline flow rate is measured by flow meter 295. Oxygenated, de-bubbled, and thermally-adjusted perfusate is pumped into the tissue in tissue holder 283 through connectors to which the tissue is attached. The tissue processes the perfusate by producing output. Some of the output exits the tissue by orifices in the tissue itself, for example, the ureter in a kidney, and some fluid becomes available based on the process. The output that exits the tissue through a tissue orifice is pumped to an output assembly as described herein. In an aspect, the other excreted fluid follows a fluid ramp into reservoir 284. The fluid ramp enables a gentle landing of the excreted fluid into reservoir 284 to avoid damage to the contents of the perfusate. The loop continues with the perfusate pumped into perfusion pump 275. In an aspect, controller 279 tracks output that is not returned to reservoir 284. An equal amount of perfusate, and nutrition/medications 297 can be added to reservoir 284 by the pumping action of infusion pump 299. In an aspect, the system includes multiple various kinds of infusion pumps, some specific for medication delivery, some specific for nutrition delivery. In an aspect, controller 279 receives data from sensors 287 and activates thermal adjustment 289 based on the data. In an aspect, controller 279 receives data from sensor 291 and flow meter 295, and adjusts the characteristics, flow rate, and possibly flow volume based on those data. In an aspect, an operator can perform manual inspection of data from the sensors and can adjust, for example, but not limited to, medications, nutrition, temperature, flow rate, oxygenation, and flow volume in the perfusate to maintain the viability of the tissue. Sensors collect data about, for example, but not limited to, glucose, dissolved oxygen, temperature, pH, oxygen saturation.

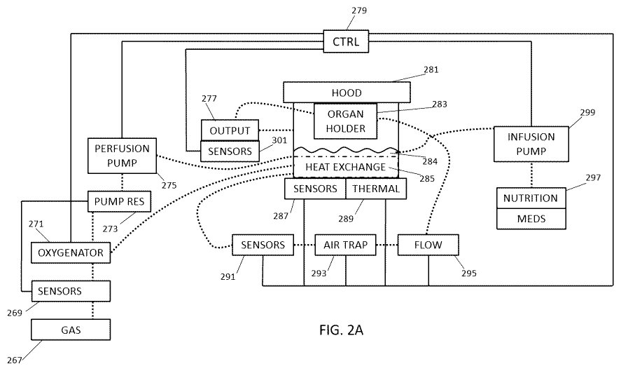

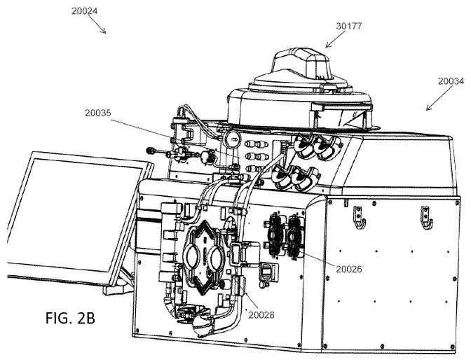

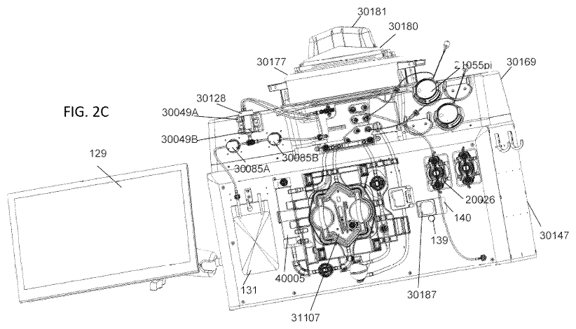

Referring now to FIGS. 2A-2C, medications and nutrition, for example, can be infused into the perfusate by at least one of infusion pump assembly 20026. As shown in FIG. 2C, the infused fluids enter the tissue container above the level of the reservoir. The perfusate exits the reservoir near the bottom of the tissue container. The controller sequences events that occur with respect to the infusion pump, and therefore delivers nutrition and medications in a timely manner. In an aspect, pumps 21055pi deliver infusion fluids at rates and volumes that are different from those characteristic of infusion pumps 20026. In an aspect, some or all of the infusion pumps can be controlled separately from each other and from controller-managed pumps, perhaps enabling asynchronous operation with the controller-managed pumps. Advantages of such a configuration include manual override of medication delivery.

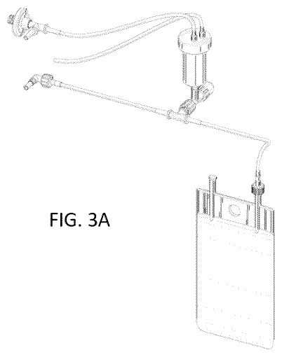

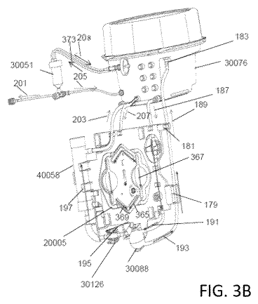

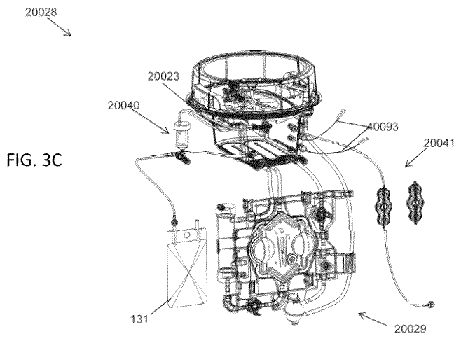

Referring now to FIGS. 3A-3C, disposable assembly 20028 is shown. Disposable assembly 20028 includes, but is not limited to including, tissue container 20023, infusion assembly 20041, and front components subassembly 20029 including perfusion subassembly, and output monitor assembly 20040. Coupling these parts to form a closed fluid loop is tubing. In an aspect, perfusate is moved through the closed loop by at least one perfusion pump, while nutrition and medication are infused in to the perfusate by at least one infusion pump. In an aspect, a single type of pump is used for both perfusion and infusion. In an aspect, a single pump is used for both perfusion and infusion. In an aspect, the perfusate is moved by at least one first kind of cassette pump and the medications and nutrition are infused by at least one second kind of cassette pump. In an aspect, the medications are infused by a first infusion pump, while the nutrition is infused by a second infusion pump. In an aspect, actions of the at least one perfusion pump and the at least one infusion pump are controlled by a controller. In an aspect, actions of at least one perfusion pump are controlled by a first controller, and actions of the at least one infusion pump are controlled by a second controller. In an aspect, actions of a first at least one infusion pump are controlled by a first controller, and actions by a second at least one infusion pump are controlled by a second controller. In an aspect, the first controller and/or the second controller can be implemented by an application that is remote to the system of the present teachings. In an aspect, tubing 40093 can couple additional pumps to tissue container 20023 to deliver infusion fluids, for example. In an aspect, output monitor 20040 can deliver tissue output to drainbag 131 and/or tissue container 20023, depending upon characteristics of the output.

Referring now to FIG. 3B, where a flow of fluids in an exemplary configuration is illustrated by arrows. Starting with fluid in a reservoir (not shown) in tissue container 30076, perfusate exits tissue container 30076 in the tubing associated with arrow 207, and enters perfusion pump 20005, and is pumped through/from perfusion pump 20005 in the direction of arrow 367/369/365. The perfusate travels past sensors in the direction of arrow 195, past pressure sensor 30126 and possibly other sensors, into oxygenator 40058, in the direction of arrow 197, and into thermal exchange area, in the direction of arrow 203. Perfusate exits thermal exchange area in the direction of arrow 187, past sensors such as a pressure sensor, in the direction of arrow 191, and into bubble trap 30088. Perfusate exits bubble trap 30088 in the direction of arrow 193, past tube guides 179 and 181 in the direction of arrow 189, and into the cannulated tissue through connector 183. Fluids associated with the functioning of the tissue drain into the reservoir, and the closed loop perfusate movement continues. If desired, output from a cannulated orifice of the tissue can flow from the tissue in the direction of arrow 373 into output monitor 30051. Depending upon, for example, the condition of the output, the fluid in output monitor 30051 can travel to drainbag 131 in the direction of arrow 201 or back to the reservoir in the direction of arrow 205. A vent line, with contents traveling in the direction of arrow 208, includes a sterile filter that vents to atmosphere. In an aspect, one end of the vent line is coupled with the tissue container, and the other end is coupled with a pump that is used to set up a slightly negative pressure, just below atmospheric pressure, within the tissue container.

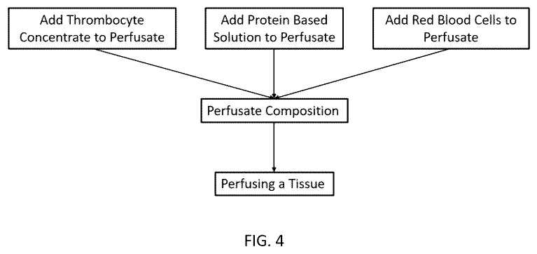

Referring now to FIG. 4, which depicts a method and composition of perfusing a tissue. In an aspect the method and composition involve adding thrombocyte concentration (TC) to a perfusate solution. In an aspect, the method and composition involve adding at least one sub element to the perfusate. In an aspect the method and composition involve adding a protein solution to a perfusate solution. In an aspect the method and composition involve adding red blood cells (RBC) to a perfusate solution. In an aspect the protein solution is fresh frozen plasma (FFP). In an aspect, the protein solution is an albumin-based solution. In an aspect, the perfusate solution is pumped through a tissue by the systems described in FIGS. 1A-3C.

One embodiment of the base perfusate may be composed of packed red blood cells (2 units=˜650 mL), human albumin (500 mL, prime system), and sodium bicarbonate (50 mL, balance pH). Additives in smaller volumes, include, but are not limited to, heparin (anticlotting), CliniMix (nutrition solution added as needed), vasodilators, dexamethasone (anti-inflammatory), calcium gluconate (quench red blood cell storage solution), and antibiotics.

The base perfusate solution disclosed above seeks to reduce pelvic (internal) bleedings in the kidneys being perfused on the presently disclosed system. Thrombocytes are needed in addition to plasma (FFP=fresh frozen plasma) and AT3 (Anti-Thrombin 3) to further reduce the bleedings. The thrombocytes and plasma provide clotting mechanism(s) which repair internal, small bleeds naturally, whereas the heparin and AT3 inhibit clot formation. Inhibition of clot formation is necessary to prevent the perfusate from clotting within the machine disposable set and kidney tissue. There is a balance between clotting and anti-clotting agents that allow for flow through the system while also repairing/inhibiting/or otherwise reducing internal kidney bleedings. After 24 hours of normothermic perfusion of the kidneys, the pelvises of kidneys tend to be bloody. Reducing pressure by half, from 45-to-90 mmHg, alone, did not appear to solve the pelvic bleeding observed.

Another embodiment of this perfusate solution may include, but is not limited to, FFP. FFP contains clotting factors such as fibrin and thrombin. The addition of FFP to the baseline perfusate further did not solve the pelvic bleeding issue. The data indicate that the FFP addition may have resulted in variable flow and less oxygen consumption, the latter potentially being a result of less total hemoglobin in the system.

Another possible embodiment of the base perfusate solution that was considered included, but is not limited to, Tranexamic Acid. Tranexamic acid blocks the breakdown of clots. The data indicate that the Tranexamic Acid resulted in severe clotting within the system, and the run was terminated within 4 hours.

Another possible embodiment of the base perfusate solution of may include, but is not limited to, AT3. The introduction of AT3 did not result in a noticeable difference in the kidney hemodynamics or bleeding. AT3 can be included as complement to heparin, to function as a safeguard to inhibit major clot formation. Thrombocytes are employed to facilitate natural clotting.

Accordingly, another possible embodiment of the base perfusate solution of paragraph 28 may include but is not limited to FFP, AT3, and Thrombocytes. This recipe limits pelvic bleeding substantially without significantly affecting the hemodynamics of the organ. The data indicate that the flow rate through the thrombocyte organs was slightly higher although urine generation appears to have been more limited. The data also indicate that the lactate was higher in the thrombocyte organs, possibly due to a lower total hemoglobin compared to the base perfusate solution. When FFP and thrombocytes are included in the base perfusate solution, pelvic bleedings are minimized. When plasma and platelets are removed in a group of porcine kidneys, bleeding throughout the tissue is observed with declining flow after approximately 15 hours and increased free hemoglobin generation. The data support the conclusion that FFP and Thrombocytes are important for reducing pelvic tissue bleeding on the system.

Another possible embodiment of the perfusate solution may include, but is not limited to, recombinant tissue plasminogen activator (rtPA) with FFP added after 24 hours. The rtPA is included to break down any clots and/or RBC aggregates left after retrieval, then the introduction clotting mechanisms protects against perfusion induced bleeding.

These together with other objects of the disclosure, along with various features of novelty which characterize the method and system of the present disclosure, are pointed out with particularity in the claims annexed hereto and forming a part of this disclosure. For a better understanding of the method and system of the disclosure, its operating advantages and the specific objects attained by its uses, reference should be had to the accompanying drawings and descriptive matter in which there are illustrated various embodiments of the method and system disclosed herein.
Alternative embodiments include:
A method for perfusing tissue, comprising:
recovering a tissue from a donor;
connecting the tissue to a machine perfusion device;
pumping the tissue with a perfusate, the perfusate having thrombocyte concentrate; and
monitoring the perfusate.
   The method of claim 24, the perfusate further comprising a protein solution.
   The method of claim 25, wherein the protein solution includes an albumin-based solution.
   The method of claim 25, wherein the protein solution includes fresh frozen plasma.
   The method of claim 24, the perfusate further comprising a bleeding reduction solution.
   The method of claim 28, wherein the bleeding reduction solution includes a thrombocyte concentrate.
   The method of claim 28, wherein the bleeding reduction solution includes Tranexamic Acid.
   The method of claim 24, the perfusate further comprising a blood clot inhibitor.
   The method of claim 31, wherein the blood clot inhibitor includes Anti-Thrombin 3.
   The method of claim 31, wherein the blood clot inhibitor includes a recombinant tissue plasminogen activator.
   The method of claim 24, the machine perfusion device further comprising a pump that pumps the perfusate through the tissue.
   The method of claim 24, wherein an infusion pump injects nutrients into the perfusate.
   The method of claim 24, wherein a controller controls the machine perfusion device.
   A system for perfusing an organ, comprising:
a machine perfusion device having a tissue container, a pump, an infusion pump, at least one reservoir, and at least one controller;
the machine perfusion device connects to a tissue by means of cannulation;
a perfusate comprised of a bleeding reduction solution and a protein solution;
the machine perfusion device pumps perfusate through the tissue when the tissue is cannulated to the device.
   The system of claim 37, wherein the bleeding reduction solution includes a thrombocyte concentrate.
   The system of claim 37, wherein the bleeding reduction solution includes Tranexamic Acid.
   The system of claim 37, wherein the bleeding reduction solution includes an endothelial cell stabilizer.
   The system of claim 37, wherein the protein solution includes an albumin-based solution.
   The system of claim 37, wherein the protein solution includes fresh frozen plasma.
   The system of claim 37, the perfusate further comprising red blood cells.
   The system of claim 37, the perfusate further comprising a blood clot inhibitor.
   The system of claim 43, wherein the blood clot inhibitor includes Anti-Thrombin 3.
   The system of claim 43, wherein the blood clot inhibitor includes a recombinant tissue plasminogen activator.
   The system of claim 37, further comprising a controller controlling the pump and the infusion pump.

Various alternatives and modifications can be devised by those skilled in the art without departing from the disclosure. Accordingly, the present disclosure is intended to embrace all such alternatives, modifications and variances. Additionally, while several example configurations of the present disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as exemplifications of particular configurations. In addition, those skilled in the art will envision other modifications within the scope and spirit of the claims appended hereto. Other elements, steps, methods and techniques that are insubstantially different from those described above and/or in the appended claims are also intended to be within the scope of the disclosure.

The drawings are presented only to demonstrate certain examples of the disclosure. And, the drawings described are only illustrative and are non-limiting. In the drawings, for illustrative purposes, the size of some of the elements may be exaggerated and not drawn to a particular scale. Additionally, elements shown within the drawings that have the same numbers may be identical elements or may be similar elements, depending on the context.

Where the term “comprising” is used in the present description and claims, it does not exclude other elements or steps. Where an indefinite or definite article is used when referring to a singular noun, e.g. “a” “an” or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B.

Furthermore, the terms “first”, “second”, “third,” and the like, whether used in the description or in the claims, are provided for distinguishing between similar elements and not necessarily for describing a sequential or chronological order. It is to be understood that the terms so used are interchangeable under appropriate circumstances (unless clearly disclosed otherwise) and that the example configurations of the disclosure described herein are capable of operation in other sequences and/or arrangements than are described or illustrated herein.

What is claimed is:

1. A composition for a machine perfusion perfusate, the perfusate comprising:
a bleeding reduction solution;
a protein solution; and
red blood cells.

2. The perfusate of claim 1, wherein the bleeding reduction solution includes a thrombocyte concentrate.

3. The perfusate of claim 1, wherein the bleeding reduction solution includes an endothelial cell stabilizer.

4. The perfusate of claim 1, wherein the bleeding reduction solution includes Tranexamic Acid.

5. The perfusate of claim 1, wherein the protein solution includes an albumin-based solution.

6. The perfusate of claim 1, wherein the protein solution includes fresh frozen plasma.

7. The perfusate of claim 1, the perfusate further comprising a blood clot inhibitor.

8. The perfusate of claim 7, wherein the blood clot inhibitor includes Anti-Thrombin 3.

9. The perfusate of claim 7, wherein the blood clot inhibitor includes a recombinant tissue plasminogen activator.

10. A method for perfusing tissue, comprising:
preparing a perfusate by adding thrombocyte concentrate to the perfusate;
adding at least one sub element to the perfusate;
connecting the perfusate to a pumping system;
connecting the pumping system to a tissue; and
pumping the perfusate through the tissue.

11. The method of claim 10, wherein one of the at least one sub elements includes a protein solution.

12. The method of claim 11, wherein the protein solution includes an albumin-based solution.

13. The method of claim 11, wherein the protein solution includes fresh frozen plasma.

14. The method of claim 10, wherein one of the at least one sub elements includes a bleeding reduction solution.

15. The method of claim 14, wherein the bleeding reduction solution includes a thrombocyte concentrate.

16. The method of claim 14, wherein the bleeding reduction solution includes Tranexamic Acid.

17. The method of claim 10, wherein one of the at least one sub elements includes a blood clot inhibitor.

18. The method of claim 17, wherein the blood clot inhibitor includes Anti-Thrombin 3.

19. The method of claim 17, wherein the blood clot inhibitor includes a recombinant tissue plasminogen activator.

20. The method of claim 10, wherein one of the at least one sub elements includes red blood cells.

21. The method of claim 10, wherein the pumping system injects nutrients into the perfusate.

22. The method of claim 10, wherein the pumping system is controlled by a controller.

23. The method of claim 22, wherein the controller controls the pumping of the perfusate.
